(19) United States
(12) Patent Application Publication
(10) Pub. No.: US 2007/0251364 A1
(43) Pub. Date: Nov. 1, 2007

(54) Rotary die cutter - cutting

(75) Inventors: Martin Blumle, Horhausen (DE); Reinhard Raueiser, Muden (DE)

Correspondence Address: OSHA LIANG L.L.P., 1221 MCKINNEY STREET, SUITE 2800, HOUSTON, TX, 77010, US

(73) Assignee: Winkler + Dunnebier Aktiengesellschaft, Neuwied (DE)

(21) Appl. No.: 11/728,052

(22) Filed: Mar. 23, 2007

(30) Foreign Application Priority Data
Mar. 23, 2006 (DE) 10 2006 013 397.8

(51) Int. Cl. B26D 7/06

(52) U.S. Cl. 83/100

(57) ABSTRACT

A device for the cutting out of flat material blanks from flat material sheets is described, which has a cutting roller and a counter roller working together with it, that form a roller gap into which the flat material sheets can be inserted for the cutting out of flat material blanks, whereby a residual material is produced. This device should be further configured in such a way that on the one hand it is connected with the least possible device expenditure, and on the other hand is not limited in its application to flat material sheets with a specified minimum length. To solve this problem, it is suggested that both the cutting roller and the counter roller be embodied as suction rollers with a covering surface that has a multiplicity of suction air openings, whereby the suction air impingement on the cutting and counter roller occurs in such a way that immediately after the cutting out, the flat material blanks are able to be further transported on the covering surface of the cutting or counter roller and the residual material on the covering surface of the counter or cutting roller.

### I. AREA OF APPLICATION

The present invention relates to a device and a procedure for the cutting out of flat material blanks from sheets of flat material. Especially this has to do with sections of thin, relatively bendable cardboard, as for example folding box sections for medication boxes or the like.

### II. TECHNICAL BACKGROUND

Folding box sections for folding boxes that for example play a significant role in the pharmaceuticals industry for packaging of medications, are produced in the flat bed punching process from an initial material that is present in the form of sheets of cardboard printed on or still to be printed on one side. For this at separate machine locations the following procedural steps on the sheets are carried out:
punching and imprinting of the flat material blanks
pressing out any interior sections from the sheets
pressing out of flat material blanks from the grid of the sheets and subsequent ejection of the flat material blanks
disposal of the remaining grid residue

In this for one thing it is disadvantageous that for each of the previously named procedural steps a separate station is present. For another, the transport of the sheets between the individual stations is relatively expensive. Additionally, with the known flat bed punching process it is extremely difficult to deliberately dispose of the waste in the form of interior cutouts and the residual grid via suction air, for an overly strong disposal suction air also would affect the surface of the folding box sections and likewise would dispose of them with excessively strong suction force. Therefore the flat bed procedure is specified that the wastes fall in a free fall into a suction system and are there safely disposed of.

It is known from DE 101 56 664 A1 to cut out folding box sections rotationally from sheets. For this, two roller pairs are used, that consist of a separator roller and a counter roller. With the help of the first roller pair, first interior cutouts are punched out from the flat material blanks. During the transport of the sheets from the first roller pair to the second roller pair, the waste of the interior cutouts is suctioned out with the help of a suctioning device. Then using the second roller pair, the exterior contours of the flat material blanks are cut out. With the help of a suctioning and removal cylinder, as well as a paring sheet, the cut-out flat material blanks are finally separated from the residual grid of the sheets.

The known device for rotational cutting out of flat material blanks from sheets also has the disadvantage of relatively large device expense. It requires altogether five rollers for cutting out and separating the sections out of or from the sheets.

### DESCRIPTION OF THE INVENTION

### a) TECHNICAL TASK

It therefore is the task of the present invention to produce a device and a procedure for cutting out or stamping out of flat material blanks from flat material sheets, that or which is linked with a minimally small device expense, and simultaneously makes possible easy disposal of the incident wastes.

### b) SOLUTION TO THE PROBLEM

This problem is solved via a device with the features of claim 1 and a procedure with the features of claim 9. Further embodiments of the present invention derive from the subordinate claims.

According to the invention a device is proposed for cutting out of flat material blanks from flat material sheets, which has a cutting roller and a counter roller working together with it, between which a roller gap is found, into which the flat material can be inserted for cutting out of flat material blanks, whereby a residual material is produced, and in which both the cutting roller and also the counter roller are each configured as suction rollers with a covering surface that has a multiplicity of suction air openings, whereby the suction air impingement of the cutting and the counter roller is done in such a way or controllable, so that directly after the cutting out, the flat material blanks can be further transported on the covering surface of the cutting or counter roller, and the residual material on the covering of the counter or cutting rollers, i.e. on the corresponding other roller. In accordance with the present invention, residual material can mean either only the residual grid of the flat material sheet, or—if in and/or between the

flat material blanks, interior cuts are provided—the residual grid and additionally the waste scraps of the interior cutouts.

The advantage of the invention is that with a single roller pair, all exterior and interior contours of the flat material blanks are cut out and simultaneously the flat material blanks are separated from the residual material, especially the residual grid. The device expense in comparison to the state of the art is correspondingly low. Further transport of the flat material sheets for the purpose of further production steps after leaving the roller gap is no longer required, since only the residual material is delivered for waste disposal. A flat material sheet bearing the sections no longer exists according to the invention-specific cutting-out procedure.

Along the contact line between the cutting roller and the counter roller, both the cutting out and the stamping out process takes place, as well as the assumption of the flat material blanks via the one roller along with the assumption of the residual material by the other roller. A selection can be made as desired within the framework of the present invention as to which of the two rollers undertakes to cut the flat material blank and which of the two rollers assumes the residual material. It is essential to the invention that after the cutting out of the flat material blanks, no joint transport takes place of the sections and of the residual material any more. Thereby according to the invention a counter cutting strip maintained separately in the machine is dispensed with. Instead of that, this, according to the invention, is situated in the covering surface of the counter roller.

Suction air openings as well as suction air channels in cutting or transport rollers for the transport of flat material blanks are known per se to the specialist. Within the framework of the present invention, to have suction air impinge on the areas of the covering surface of the cutting roller or the covering surface of the counter roller adapted to the geometry of the flat material blanks or of the residual material, suction channels regulated by suction air can be provided in the rollers, whose suction impingement can be regulated with the help of suitable control valves. Conceivable as an alternative is to masking-tape off those

suction air openings of the cutting roller or of the counter roller, on which, due to the geometry of the flat material blanks or of the residual material, no suction action is desired, with a tape ribbon or the like. As an additional alternative, suction air openings of the cutting roller or of the counter roller on which, due to the geometry of the flat material blanks or of the residual material no suction action is desired, are covered by foil sheets bearing cutting tools, that are mounted detachably on the covering surfaces of the cutting or counter rollers.

In connection with the application of control valves for suction air impingement of the suction channels, according to the invention it is advantageous that for each, or on each, of the two rollers, only a single control valve is required. This advantage derives from joint further transport of the flat material blanks and of the residual material on the covering surface not taking place on one and the same roller. If joint further transport in the sense previously mentioned occurs, then, to cause the desired separation of the flat material blanks from the residual material, it would be required to impinge the suction air openings assigned to the particular flat material blank on the one side and the suction air openings assigned to the residual material on the other side in the circumferential direction of the roller over variously long angular and transport sections. The latter in turn would make it necessary to place two different control valves on the roller, which complicates the suction air system and can be undesirable for space reasons.

Instead of that, the present invention makes it possible, especially in the area of the bearing for each of the two rollers, to save space by providing only a single control valve per roller. For this, the control valve of the cutting roller exclusively regulates its suction air impingement for holding, transporting and releasing the flat material blanks, while the control valve for the counter roller exclusively controls its suction air impingement for holding, transporting and releasing of the residual materials, or vice versa.

It is especially advantageous if the cutting roller is formed as a combined cutting and stamping roller for cutting out of the flat material blanks and simultaneous generation of impressions and/or preliminary breakthroughs in the flat material blanks. The impressions to be generated may on the one hand be logo or text impressions or on the other hand imprinted preliminary breakthrough lines. The latter are material weakenings in the form of channelings in the flat material blank, along which later folds are made as part of manufacturing folding boxes from the flat material blanks. If the cutting roller is formed as a combined cutting and stamping roller, then in advantageous fashion a separate stamping station is dispensed with in the manufacturing machine and the invention-specific device assumes the functions of cutting out, stamping and separating the flat material blanks from the residual material (effective separation).

The cutting roller and counter roller are pressed against each other via suitable devices, to generate the required cutting and/or stamping force in the roller gap. The line of action of the corresponding pressure can thereby run through the turning center of the cutting and counter rollers. According to the invention, the cutting and counter rollers can be fulcrumed and guided with play in the direction standing perpendicular to the previously-mentioned line of action. In this case it is advantageous not to place the two rollers so that the previously-mentioned line of action runs exactly through both turning centers of the rollers. Rather, the rollers can be placed so that their turning centers lie displaced to each other in the direction standing perpendicular on the line of action. Thereby the two rollers always press in a stable equilibrium position. With a placement with a line of action running precisely through both turning centers, an unsteady equilibrium would be produced, which during operation of the invention-specific device would lead to an oscillation or clattering of the rollers relative to each other and can thus cause poor or unusable cutting or stamping results.

The transport of flat material sheets in the roller gap between cutting roller and counter roller can occur either only with the help of a separate transport device

or additionally with the help of the cutting or counter roller itself. For this the rollers are arranged offset to each other so that one of the two rollers with its covering surface impinged on by suction air grasps the flat material sheet on its front end and transports it on into the roller gap. According to the need, additional guidance devices can be provided which ensure that the flat material sheet, in adjoining the covering surface of one of the two rollers, is pressed and transported to the roller gap.

According to the invention, in addition a procedure is suggested for the cutting out of flat material blanks from flat material sheets, in which flat material sheets are inserted for cutting out flat material blanks into a roller gap between a cutting roller and a counter roller working together with it, and a residual material is produced, and in which, immediately after the cutting out of the flat material blanks, these are held via suction air on the covering surface of the cutting or counter roller, as well as being transported forward on it, while the residual material, via suction air, is held on the covering surface of the counter or cutting roller as well as being transported forward on it, so that immediately after the cutting out, a separation of the flat material blanks from the residual material occurs.

### c) EMBODIMENT EXAMPLES

Multiple embodiment forms of the present invention are described in greater detail in the following as examples using the appended figures. Shown are:

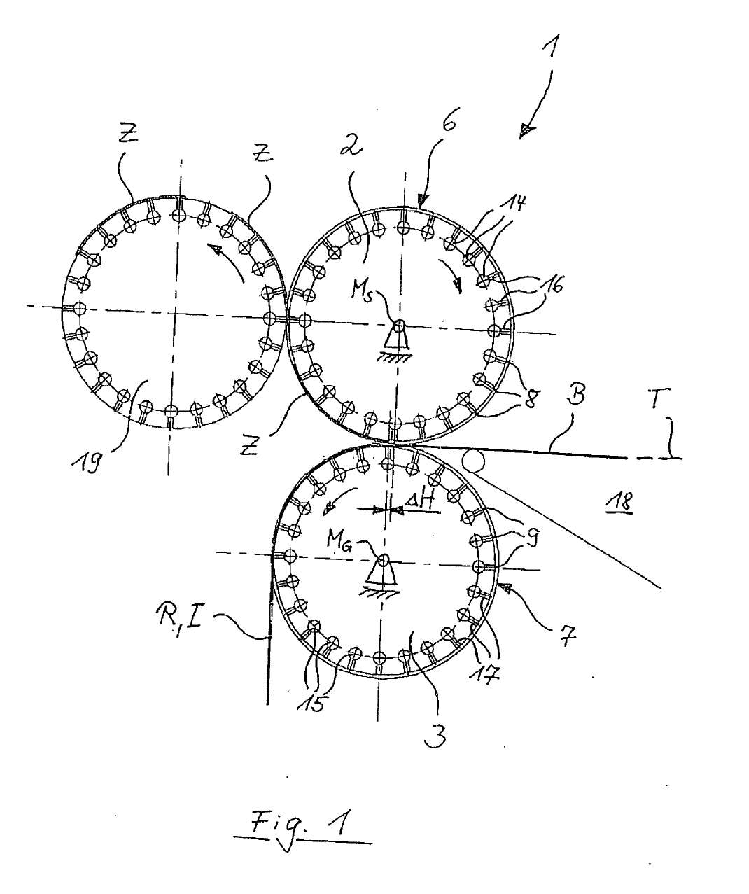

FIG. 1: a first embodiment form of an invention-specific device;

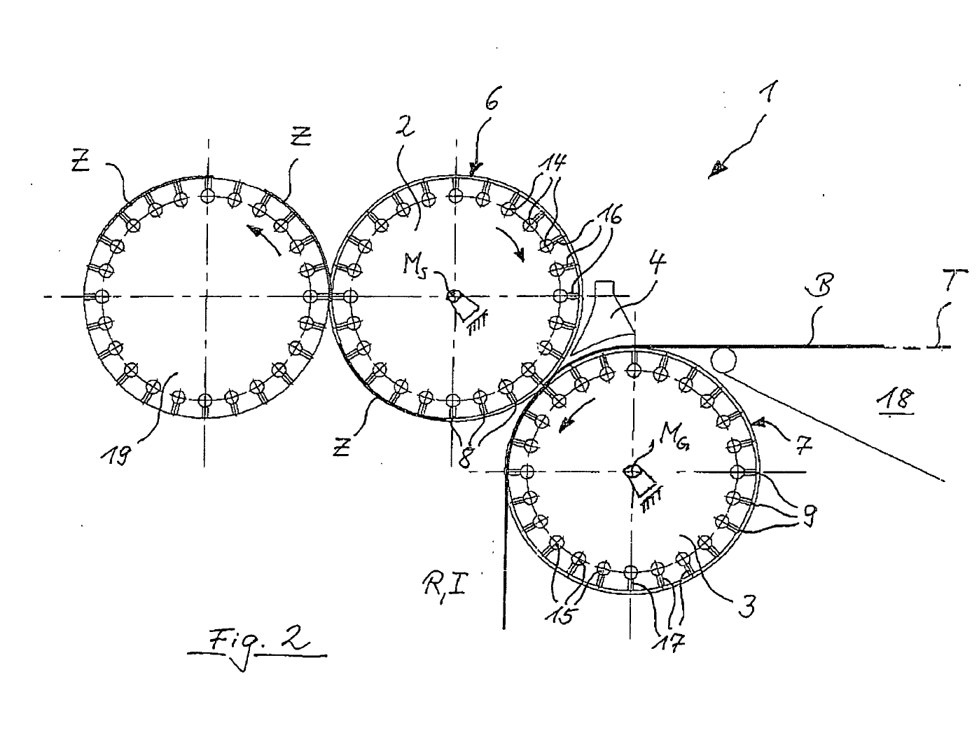

FIG. 2: a second embodiment form of an invention-specific device;

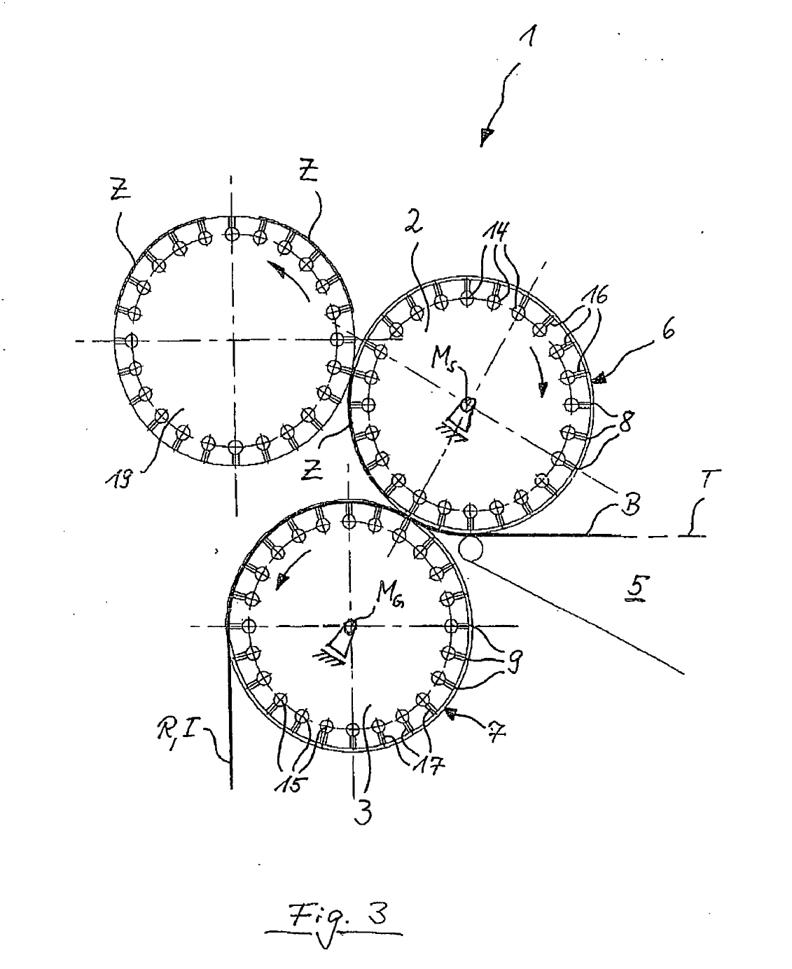

FIG. 3: a third embodiment form of an invention-specific device;

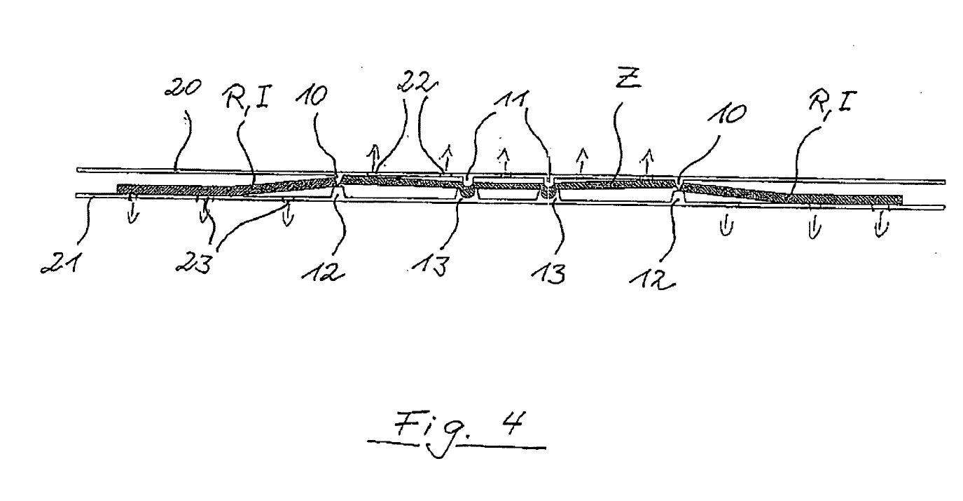

FIG. 4: a section view of the roller gap that shows the various temporally consecutively appearing situations in the roller gap; and

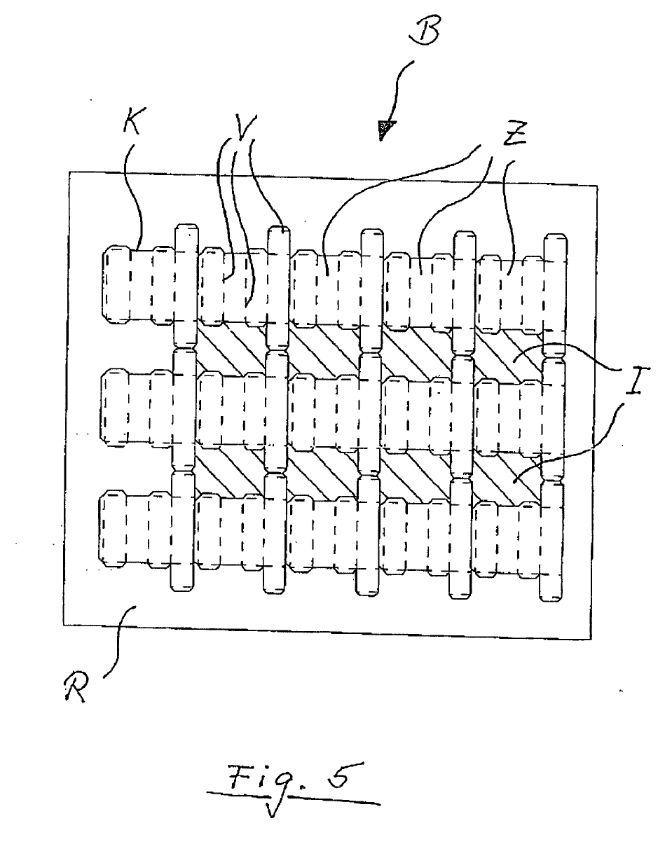

FIG. 5: an exemplary arrangement of the flat material blanks on a flat material sheet.

FIG. 1 shows a first embodiment form of an invention-specific device 1 in a schematic section depiction. Placed above a transport plane T, a cutting roller 2, as well as a counter roller 3 placed beneath the transport plane T, are perceived. Preferably cutting roller 2 and counter roller 3 have the same roller diameter.

In all shown embodiment forms, cutting roller 2 is embodied as a combined cutting and stamping roller. For simplicity it is nonetheless designated as a cutting roller in what follows. As is perceived in the section depiction as per FIG. 4, on its covering surface 6 it bears a closed circumferential cutting knife 10, which in the top view corresponds to the peripheral geometry of the flat material blank to be produced. In addition, the covering surface 6 of cutting roller 2 has multiple punches 11 for generation of preliminary breaks or fold lines in the flat material blanks. As likewise is perceived in FIG. 4, the counter roller 3 on its covering surface 7 bears a counter cutting strip 12 working together with cutting knife 10 and correspondingly circumferentially closed, as well as with the matrices 13 that work together with the punches 11.

Cutting roller 2 and counter roller 3 can be embodied as solid rollers, so that the cutting knife 10 and the counter cutting strip 12 or the punches 11 and the matrices 13 are placed on them as a single piece. However, the alternative is advantageous, to embody the cutting knife 10 and the punches 11 or the counter cutting strip 12 and the matrices 13 on foil sheets, that can be detachably secured to the covering surfaces 6 or 7 of cutting roller 2 or counter roller 3. Thus cutting roller 2 is distinguished in that it has the active cutting or stamping tools, while counter roller 3 is equipped with the passive cutting or stamping tools. Naturally in all the described embodiment forms, cutting roller 2 can be embodied purely as a cutting roller, so that it bears exclusively the active cutting tools, while then the counter roller 3 bears exclusively the passive cutting tools.

In FIG. 1, the suction air channels 14 and 15 are perceived running axially in the cutting roller 2 and counter roller 3. Each of them is arrayed to be distributed evenly over a hole circle that has a somewhat smaller diameter than that of cutting roller 2 or counter roller 3. Each suction air channel 14 or 15 is in flow connection via several in essence radially running suction air boreholes 16 and 17 with the covering surface 6 and 7. The suction air boreholes 16 and 17 for their part empty out into suction air openings 8 and 9 in covering surfaces 6 and 7. In this way, suction rows arise on covering surfaces 6 and 7 in an axial or viewed direction of FIG. 1, each of which consists of a multiplicity of suction air openings 8 and 9.

A flat material sheet B of the type shown in FIG. 5 is brought from the right in FIG. 1 in the transport plane T with the help of a transport device 18, which preferably is a suction belt transport device, to the roller gap between cutting roller 2 and counter roller 3. Cutting roller 2 rotating clockwise as well as counter roller 3 rotating counterclockwise pull flat material sheet B into the roller gap. There, with the help on the one hand of cutting knife 10 shown in FIG. 4 and counter cutting strip 12 shown in FIG. 4, the contours of the flat material blanks are cut out or punched out, as well on the other hand, with the help of the punches 11 and matrices 13 shown in FIG. 4, generating the desired preliminary breakthrough lines in the form of channelings.

The contour K cut out of flat material blanks Z is depicted in FIG. 5 by continuous lines. The flat material blanks Z are folding box sections of cardboard for production of medication boxes. Naturally, within the framework of the present

invention, flat material blanks Z can be manufactured for any other purposes, especially packaging purposes. The preliminary breakthrough lines V, along which the medication boxes are folded during later manufacturing, and which thus form the later edges of the medication box, are depicted in FIG. 5 by dashed lines. From the flat material sheet B shown in FIG. 5, three rows of flat material blanks Z were cut out, whereby in each row five flat material blanks Z are configured. The material that in FIG. 5 surrounds the flat material blanks Z in the outer area of flat material sheet B, and is depicted without hatching, is designated as residual grid R. The material that lies between the individual rows of flat material blanks Z that is shown by hatches in FIG. 5, is so-called interior cutouts I of flat material sheet B. Interior cutouts in the form of windows and the like can also be configured in the flat material blanks Z themselves. The residual grid R and the interior cutouts I together form the residual material to be disposed of.

As is perceived in FIG. 1, after leaving the roller gap, the flat material blanks Z adhere to the covering surface 6 of cutting roller 2. They are transported forward on covering surface 6 in the embodiment form shown around a section angled at about 90° before they are transferred to a transport roller 19, that is likewise embodied as a suction roller. Also conceivable as an alternative is any other kind of transport device to accept flat material blanks Z from cutting roller 2. Transport roller 19 transports the cutting material sections Z to a storage area or if necessary to an adjoining station of the manufacturing machine in which a further production step is carried out.

After leaving the roller gap, the residual grid R as well as the interior cutouts I are held by means of suction air on the covering surface 7 of counter roller 3 and brought to a waste disposal location. Preferably in FIG. 1 to the left beneath counter roller 3 a secure and low-loss suction funnel is placed, which can deliberately act on the residual material to be disposed of.

The suction air impingement of suction air openings 8 in cutting roller 2 occurs in such a way that only those suction air openings 8 that lie within the contours K of the flat material blanks Z display a suction action. Thus, the suction air impingement of suction air openings 9 of counter roller 3 occurs in such a way that exclusively those suction air openings 9 display a suction action, that lie outside the contour K of flat material blanks Z and consequently with which they affect through the suction air drawn through them the residual grid R and the interior cutouts I.

As shown schematically in FIG. 1, cutting roller 2 and counter roller 3 are situated within a certain play to be forced to go horizontally. To ensure a stable equilibrium position, the turning center M_{S} of cutting roller 2 and the turning center M_{G} of counter roller 3 doe not lie exactly vertical above each other, but are offset in a horizontal direction to each other by an offset ΔH. The line of action of the pressure by which cutting roller 2 in FIG. 1 is compressed from above to below against counter roller 3 therefore does not run through the turning center M_{G} of counter roller 3, rather past it on the right. The offset ΔH is less than 10% of the diameter of cutting roller 2 or counter roller 3, preferably less than 5% of the roller diameter, and still further preferred less than 2% of the roller diameter. With the help of the offset ΔH it is avoided that cutting knife 10 and the punches 11 make clattering oscillations relative to counter cutting strip 12 and the matrices 13 during the cutting or stamping process, and thereby causing poor or unusable cutting and stamping results. In FIG. 1, due to the offset ΔH the cutting roller 2 is always pressed to the right and counter roller 3 always to the left, each in a stable equilibrium position.

FIG. 2 shows the section depiction of a second embodiment form of an invention-specific device 1. The same reference designators as in FIG. 1 designate the same parts. Here what differs from the embodiment form according to FIG. 1 is that counter roller 3 lying beneath transport plane T is displaced by about ¾ of the roller diameter to the right relative to counter roller 2.

An offset ΔH according to FIG. 1, not shown in FIG. 2, is also provided in this embodiment form. The line of action of the pressure here runs inclined at roughly 45° relative to the horizontal. The cutting roller 2 and counter roller 3 placed with play in the direction standing perpendicular to the line of action of pressure constantly press to a stable equilibrium position.

As is perceived, first the covering surface 7 of counter roller 3, impinged on by suction air, takes flat material sheets B from the transport device 18. Adhering to the covering surface 7, the flat material sheets B are then fed to the roller gap between cutting roller 2 and counter roller 3. There, as with the embodiment form as per FIG. 1, the invention-specific cutting and stamping processes occur. For support of the feeding of flat material sheets B on covering surface 7 of counter roller 3, in the area before the roller gap a guiding device 4 is provided. Its surface facing counter roller 3 preferably is at least partially adapted to the curvature of covering surface 7.

Thus in FIG. 2, counter roller 3 bearing the passive cutting and stamping tools, assumes the transport of flat material sheets B to the roller gap. Conceivable as an alternative is to exchange cutting roller 2 and counter roller 3, so that then cutting roller 2 bearing the active cutting and stamping tools assumes the transport of flat materials sheets B to the roller gap.

FIG. 3 shows the section depiction of a third embodiment form of an invention-specific device 1. The same reference symbols designate the same parts as in the embodiment form according to FIG. 1. Differing from the first and second embodiment form, in FIG. 3 the cutting roller 2 is displaced by about half the roller diameter to the right relative to counter roller 3. An offset ΔH according to FIG. 1, not drawn in FIG. 3, is also provided with this embodiment form. The line of action of the pressure in this embodiment form is inclined by about 60° relative to the

horizontal. Thus cutting roller 2 and counter roller 3 also here press toward a mechanically stable equilibrium position.

As is perceived, the flat material sheets B fed by a transport device 5, preferably a suction belt transport device, are first accepted by a covering surface 6 of cutting roller 3 impinged on by suction air, before they are transported on to the roller gap. Especially advantageous in this embodiment form is that the flat material blanks Z are not forced to alter their curvature orientation after leaving the roller gap. Even before reaching the roller gap, flat material sheet B assumes the curvature orientation of covering surface 6 of cutting roller 2, so that the cut-out flat material blanks Z can maintain this curvature orientation already assumed beforehand, since on the covering surface 6 they are transported on to transport roller 19. Preferably transport device 5 extends to the area vertically beneath the turning center Ms of cutting roller 2, so that there the flat material sheets B can be accepted tangentially from the covering surface 6 impinged on by suction air.

In the embodiment form shown in FIG. 3, cutting roller 2 bearing the active cutting or stamping tools transports the flat material sheets B to the roller gap. Due to the curvature orientation generated even before the cutting or stamping of flat material sheet B, which can be maintained after the cutting or stamping of the flat material blanks Z, this embodiment form is especially advantageous. However, also conceivable as an alternative is to exchange cutting roller 2 and counter roller 3, so that counter roller 3 which then lies above transport plane T and bears the passive cutting and stamping tools, transports the flat material sheets on to the roller gap.

The surface distribution of suction air impingement on covering surfaces 6 and 7 of cutting roller 2 or counter roller 3 is always guided according to the geometry of flat material blanks 7 or the geometry of the residual material. Therefore, during transport to

the roller gap, the flat material sheets B in the embodiment forms according to FIGS. 2 and 3 are not fully affected by the suction air action, rather in FIG. 2 only by those suction air openings 9 that match the geometry of the residual material, and in FIG. 3 only by those suction air openings 8 that match the geometry of the flat material blanks Z.

FIG. 4 shows parts of two foil sheets 20 and 21 unrolled in the plane. The foil knife 20 bearing the cutting knife 10 and the punches 11 is situated on the covering surface 6 of cutting roller 2. It is equipped with suction air perforations 22 that align with certain suction air openings 8 in an installed state. The foil knife 21 bearing the counter cutting strip 12 and the matrices 13 is placed on covering surface 7 of counter roller 3. The suction air perforations 23 provided in it align, in an installed state, on covering surface 7 with certain suction air openings 9. Thus, especially advantageously, it makes possible the use of detachable mountable foil sheets 20, 21, to close those suction air openings 8, 9 whose sucking action in regard to the geometry of the flat material blanks Z or of the residual material R, I is not desired.

### LIST OF REFERENCE SYMBOLS

1 Device
2 Cutting roller
3 Counter roller
4 Guiding device
5 Transport device
6,7 Covering surface
8,9 Suction air opening
10 Cutting knife
11 Punch
12 Counter cutting strip
13 Matrix
14,15 Suction air channel
16,17 Suction air borehole
18 Transport device
19 Transport roller
20,21 Foil sheet
22,23 Suction air perforation
B Flat material sheet
I Interior cutout
K contour of flat material blanks Z
M_{S} Turning center of cutting roller 2
M_{G} Turning center of counter roller 3
R Residual grid
T Transport plane
V Preliminary breakthrough line
Z Flat material blank

1. A device for the cutting out of several utility forming flat material blanks each from a flat material sheet, comprising:
a cutting roller and a counter roller acting together with it, which form a roller gap into which the particular flat material sheet for the cutting out of the flat material blanks is insertable, whereby both a residual grid and also interior cutouts in and/or between the flat material blanks are produced,
characterized in that
both the cutting roller and also the counter roller are embodied as suction rollers with a covering surface, that has a multiplicity of suction air openings, whereby the suction air impingement of the cutting and the counter roller occurs in such a way that immediately after the cutting out, the flat material blanks can be transported forward on the covering surface of the cutting or counter roller and the residual grid together with the interior cutouts on the covering surface of the counter or cutting roller,
and whereby the cutting roller additionally is configured as a stamping roller for generation of impressions and/or preliminary breakthroughs in the flat material blanks, and the counter roller is appropriately adapted.

2. The device according to claim 1,
characterized in that
the cutting roller and the counter roller can be pressed against each other with a pressure and are supported with play in the direction standing perpendicular to the line of action of pressure, as well as offset (ΔH) to each other.

3. The device according to claim 1,
characterized in that
the cutting roller and the counter roller are embodied in such a way that the flat material sheets can be grasped by the suction air openings of the counter roller and are able to be fed on a part of their covering surface to the roller gap.

4. The device according to claims 1,
characterized in that
the cutting roller and the counter roller are embodied in such a way that the flat material sheets can be grasped by the suction air openings of the cutting roller and are able to be fed on a part of their covering surface to the roller gap.

5. The device according to claim 3,
characterized in that
a guiding device for guiding the flat material sheets along the covering surface of the counter or the cutting roller is provided.

6. The device according to claim 3,
characterized in that
a transport device for feeding the flat material sheets projects into an area vertically beneath the turning center of the counter or the cutting roller so that there the flat material sheets can be transferred to the counter or the cutting roller.

7. The device according to claim 6,
characterized in that
the transport device is a suction belt transport device.

8. A procedure for the cutting out of multiple utility forming flat material blanks each from a flat material sheet, in which the particular flat material sheet for the cutting out of flat material blanks is fed into a roller gap between a cutting roller and a counter roller working together with it,
and as residual material both a residual grid and also interior cutouts in and/or between the flat material blanks are produced,
characterized in that
directly after the cutting out, the flat material blanks are held via suction air on the covering surface of the cutting or counter rollers as well as transported further on this, and the residual grid together with the interior cutouts are held via suction air on the covering surface of the counter or cutting roller, as well as transported further on it, so that immediately after the cutting out, a separation of the flat material blanks from the residual grid and the interior cutouts takes place.

9. The procedure according to claim 8,
characterized in that
during the cutting out, simultaneously a stamping of the flat material blanks occurs, so that they have imprints and/or preliminary breakthroughs.

10. The procedure according to claim 8,
characterized in that
before reaching the roller gap, the flat material sheets are held via suction air at least partially on the covering surface of the counter or the cutting roller and are thus fed to the roller gap.

11. The device according to claim 2,
characterized in that
the cutting roller and the counter roller are embodied in such a way that the flat material sheets can be grasped by the suction air openings of the cutting roller and are able to be fed on a part of their covering surface to the roller gap.

12. The device according to claim 4,
characterized in that
a guiding device for guiding the flat material sheets along the covering surface of the counter or the cutting roller is provided.

13. The device according to claim 4,
characterized in that
a transport device for feeding the flat material sheets projects into an area vertically beneath the turning center of the counter or the cutting roller so that there the flat material sheets can be transferred to the counter or the cutting roller.

14. The procedure according to claim 9,
characterized in that
before reaching the roller gap, the flat material sheets are held via suction air at least partially on the covering surface of the counter or the cutting roller and are thus fed to the roller gap.
